(19) United States
(12) Patent Application Publication
(10) Pub. No.: US 2011/0188342 A1
(43) Pub. Date: Aug. 4, 2011

(54) DEVICE AND METHOD FOR ACOUSTIC DISPLAY

(75) Inventor: Thomas Sporer, Fuerth (DE)

(73) Assignee: Fraunhofer-Gesellschaft zur Foerderung der angewandten Forschung e.V., Munich (DE)

(21) Appl. No.: 12/922,910

(22) PCT Filed: Mar. 17, 2009
(86) PCT No.: PCT/EP09/01963

§ 371 Date: Nov. 8, 2010

Related U.S. Application Data
(60) Provisional application No. 61/038,209, filed on Mar. 20, 2008.

(51) Int. Cl. G01S 7/56; G01S 3/80; G01S 13/06

(52) U.S. Cl. 367/7; 367/118; 342/146

(57) ABSTRACT

A device for acoustic display of a position of an object in a reproduction space, a plurality of loudspeakers being arranged in the reproduction space at spatially different positions such that different spatial positions may be represented acoustically by differently driving the loudspeakers, includes a signal associater and a loudspeaker driver. The signal associater is configured to associate an acoustic signal to the object. The loudspeaker driver is configured to establish one or several loudspeaker signals for the plurality of loudspeakers, wherein the one or several loudspeaker signals by which the position of the object is displayed are based on the acoustic signal associated to the object by the signal associater. The one or several loudspeaker signals may be established such that, when reproducing the one or several loudspeaker signals, the position of the object in the reproduction space is displayed acoustically.

### BACKGROUND OF THE INVENTION

The present invention relates to a device and a method for acoustic display of a position of an object in a reproduction space. Embodiments in particular include acoustic displays for being used on board of ships.

Many optical displays (such as, for example, of sensors) which, on the one hand, monitor the technical equipment of the ship and, on the other hand, provide information on the environment above and below the water and, in particular, on obstacles are to be found frequently on the bridge or in the machine operation center of medium-sized and big ships. Usually, several persons are on the bridge or in the operation center for controlling the ship. With an increasing number of reporting sensors, generating distinguishable signals becomes more and more important, wherein warnings and information must, for example, be distinguished. Apart from the optical display, acoustic reporting is particularly desirable. While rarely occurring notifications can be supported by means of speech output, the announcement of frequently occurring notifications, as provided by radar devices or sonars, for example, is considerably more complex. Known art from the automotive sector would be gap sensors reproducing beep tones of variable frequencies. Exemplarily, the frequency may vary when approaching an obstacle at decreasing distance. However, this does not provide sufficient information on ships, since movable obstacles may be located and move in any direction.

### SUMMARY

According to an embodiment, a device for acoustic display of a position of an object in a reproduction space, at least three loudspeakers being arranged in the reproduction space at spatially different positions so that different spatial positions may be represented acoustically by differently driving the loudspeakers, may have: signal associating means configured to associate an acoustic signal to the object in dependence on the distance of the object and the danger potential connected thereto; and loudspeaker driving means configured to establish one or several loudspeaker signals for the at least three loudspeakers, wherein the one or several loudspeaker signals by which the position of the object is displayed are based on the acoustic signals associated to the object by the signal associating means, and wherein the one or several loudspeaker signals may be established such that, when reproducing the one or several loudspeaker signals, the position of the object in the reproduction space is displayed acoustically.

According to another embodiment, a device for scanning an environment may have: a sensor for determining a position of an object in the environment; and a device for acoustic display as mentioned above coupled to the sensor and receiving the position of the object from the sensor.

According to another embodiment, a method for acoustic display of a position of an object in a reproduction space, at least three loudspeakers being arranged in the reproduction space at spatially different positions such that different positions may be represented acoustically by differently driving the loudspeakers, may have the steps of: associating an acoustic signal to an object in dependence on the distance of the object and the danger potential connected thereto; and establishing one or several loudspeaker signals for the at least three loudspeakers, wherein the one or several loudspeaker signals by which the position of the object is displayed are established based on the acoustic signal associated to the object by the signal associating means, and wherein the one or several loudspeaker signals are established such that, when reproducing the one or several loudspeaker signals, the position of the object in the reproduction space is displayed acoustically.

Another embodiment may have a computer program having program code for performing the method for acoustic display as mentioned above when the computer program runs on a computer.

The central idea of the present invention is arranging a plurality of loudspeakers in a reproduction space differently in space such that different positions may be represented acoustically by differently driving the loudspeakers. In particular, signal associating means is configured to associate an acoustic signal to the object, and loudspeaker driving means is configured to establish one or several loudspeaker signals for the plurality of loudspeakers. The one or several loudspeaker signals are such that they display the position of the object, the one or several loudspeaker signals being based on the acoustic signal associated to the object by the signal associating means. The one or several loudspeaker signals are established such that, when reproducing the one or several loudspeaker signals, the position of the object in the reproduction space is displayed acoustically.

Embodiments of the present invention further relate to how, using intelligent acoustic displays, sensor signals may be represented more easily and thus security may be improved and the overhead be reduced. Another idea of the present invention is based on the fact that a considerable portion of the information is a display of position in many reporting devices. Radar, sonar, nautical charts or weather charts may, for example, be used as reporting devices and the display of position here exemplarily relates to a direction or to a distance to the object. A sound field which naturally encodes this information as precisely as possible is, for example, generated by means of several loudspeakers so as to report or represent the direction or distance.

When cooperating with the optical displays of radar and sonar used so far, it is practical to only augment the most important or important objects when acoustically representing the environment. These are objects which may, for example, be approaching or the course of which would cross the course of the ship, resulting in a danger of collision.

Based on reproduction systems for spatial audio signals in the field of entertainment and in the field of virtual reality, it is possible to make the walls virtually disappear, also in small spaces, so that the position of an object (distance and direction) can be heard precisely even outside the reproduction space.

There are basically two ways of driving the loudspeakers:
(i) Wave field synthesis (WFS): in this system, the loudspeakers are exemplarily located at a constant distance and the individual signals for the loudspeakers are calculated in accordance with the known WFS algorithms. Objects from a radar signal here are reproduced as acoustic objects in a corresponding direction and distance. The objects appear as virtual sound sources and can be localized by a listener. All the persons on the bridge may exemplarily perceive the object at the same location. It is also possible to acoustically represent not only an individual object, but also several objects at the same time, wherein another or, optionally, even an equal acoustic signal may, for example, be associated to each object.
(ii) Time and amplitude panning (TAP): in this method, an acoustic sound signal is altered in its amplitude and phase for the individual loudspeakers such that the acoustic signal appears to come from a certain direction and at a certain distance. With this system, it is also possible to allow greater and/or different distances between the loudspeakers. This method, compared to WSF, is of advantage in that fewer loudspeakers are needed, but of disadvantage in that the acoustic position of a sound source is perceived less precisely. The perceived location of the sound source may also be somewhat dependent on the position of the person listening.

In order to acoustically represent a radar signal, same is at first processed acoustically. Processing here includes, on the one hand, recognizing movable objects, such as ships and planes, and additionally recognizing static objects, such as, for example, the coastline, buoys or islands. In objects which contain a transponder and identify themselves by means of text (text message or generally data), the audio signal may optionally be converted to an audio signal by means of text-to-speech identification so that the text signal of the transponder will be audible. Such objects are, for example, certain buoys or beacons the identifiable information of which exemplarily appear on the radar as text.

Objects may also be classified corresponding to their danger potential. Exemplarily, objects approaching (from the front or, faster, from behind) or crossing the path of movement of the ship may be classified as being more dangerous than objects passing in parallel to the ship or moving away from the ship. Objects which are further away are usually considered to be less dangerous than objects which are close or are approaching at great relative speed. Depending on the danger, a different identification tone may be associated to the objects, wherein the identification tone may exemplarily differ in pitch or in impulse succession frequency and increase with increasing danger. Thus, a higher tone may indicate a greater danger or increasing loudness may imply increasing danger. Similarly, a fast-beating clock impulse may indicate an increasing or higher danger than a low clock impulse (when exemplarily the identification tone is represented as a rhythmic clock impulse).

The audio signals of the objects, generated in this way, are then exemplarily reproduced by WFS or TAP mentioned above, by which objects further away automatically decrease in loudness.

In further embodiments, in particular in surroundings such as, for example, shipping routes, non-dangerous objects are faded out completely (not reproduced) in order not to stress the person navigating or the listener with too much information.

Additionally, the position of reproduction may, in embodiments, appear at the same distance as the actual distance, i.e. when the radar indicates the object to be at a distance of one kilometer, the audio object will also be perceivable at a distance of one kilometer (1:1 mapping). Alternatively, the position of reproduction is scaled correspondingly so that, for example, 1:100 mapping is performed and an object at a distance of one kilometer is perceivable acoustically or reproduced by an acoustic signal at a distance of approximately ten meters (virtual sound source). The first one (1:1 mapping) is, for example, of advantage in that in WFS there are no parallax errors whatsoever, so that the distance of the object is only encoded by the loudness and no longer by the curved wave form. However, objects at great distances would only be audible very late as a result of the speed of sound, and, additionally, with 1:1 representation, objects at great distances can hardly be distinguished in terms of distance.

Embodiments are aimed at encoding objects using audio signals in order for those to be locatable in the best way possible. In order to achieve this, the audio signals should be of a sufficiently broad band, since a sinusoidal tone, for example, is difficult to perceive. Correspondingly, narrow-band noise or speech should rather be used for identifying objects—but not a sinusoidal tone. In order to be able to reproduce and additionally also be able to perceive acoustically a high number of objects in dense environments, such as, for example, nautical routes, pulsed signals are emitted instead of continuous signals (such as, for example, a continuous tone). The pulse frequency here may increase with increasing danger, similarly to parking sensors in automobiles. In order to allow permanent usage, the audio signals should emit a pleasant sound as long as the danger is sufficiently low. The danger threshold, above which there is serious danger and below which there is no or hardly any danger potential, is exemplarily set variably corresponding to the circumstances. The danger threshold may optionally also be adjusted by the user. The size and speed of a ship or also the speeds of the other objects, for example, play a role. The threshold value may exemplarily be established from the ratio of the duration up to a pre-calculated collision and stopping time of the ship.

The pleasant sound of the audio signals may exemplarily be achieved by using a low center frequency of the narrow-band noise with non-identified objects (e.g. objects not representing a danger) or a low pulse frequency (rare representation). Alternatively, spectral coloration of the narrow-band noise may also be used where high frequencies are of less energy than low ones (cutting using bandpass from pink noise). With identified objects, this is achieved by rare reporting, such as, for example, at first contact to then only transmit new signals at an interval of minutes.

The reporting signal may optionally be selected such that it may be located precisely and be distinguished from ambient noise. Additionally, it is of advantage for the reporting signal to have a pleasant sound so that the system will be accepted permanently also on long journeys. A considerable advantage of acoustic displays including spatial resolution is that, in contrast to optical displays, they may be used by a person simultaneously with the natural environment. The natural environment may exemplarily include visual navigation or also hearing ships and buoys. This allows producing so-called augmented reality.

Embodiments are of advantage in particular since they provide an important synergy effect between acoustic and optical displays. The acoustic display is reported and perceived, whereby prioritization according to danger may take place, whereas the optical display needs the attention of the persons on the bridge. A person navigating, for example, will only see an object on the radar screen when looking at the radar screen. However, he will not be looking out of the window at the same time and will thus lose part of the information of what is going on in his closer environment. Acoustic displays allow using the information from the radar and from looking out of the window simultaneously. In particular with non-self-identifying objects, an experienced evaluator is able to classify an object from the radar image (as, for example, being a ship, an island or image interference). It follows that the cooperation of the acoustic perception (an object is present) and having a look at the radar screen is an important synergy effect for control. With self-identifying objects at great distances, the identification can be read at any time by having a look at the radar screen.

The above and other elements, features, steps, characteristics and advantages of the present invention will become more apparent from the following detailed description of the preferred embodiments with reference to the attached drawings.

### BRIEF DESCRIPTION OF THE DRAWINGS

Embodiments of the present invention will be detailed subsequently referring to the appended drawings, in which:

FIG. 1 shows a schematic illustration of a device for acoustic display in accordance with an embodiment of the present invention;

FIG. 2 shows an illustration of an inventive system comprising a sensor for determining the position of an object;

FIG. 3a show illustrations of position-dependent signals for acoustically perceiving

and 3b increasing danger;

FIG. 4 shows an embodiment comprising a plurality of loudspeakers for acoustically representing two separate objects;

FIG. 5 shows a schematic illustration of a reproduction space including a WFS module; and

FIG. 6 shows a basic block diagram of a wave field synthesis system including wave field synthesis modules and a loudspeaker arrays in a reproduction space.

### DETAILED DESCRIPTION OF THE INVENTION

With regard to the following description, it should be kept in mind that same functional elements or functional elements having the same effect comprise same reference numerals in different embodiments and that the description of these functional elements in the different embodiments illustrated below is thus mutually exchangeable.

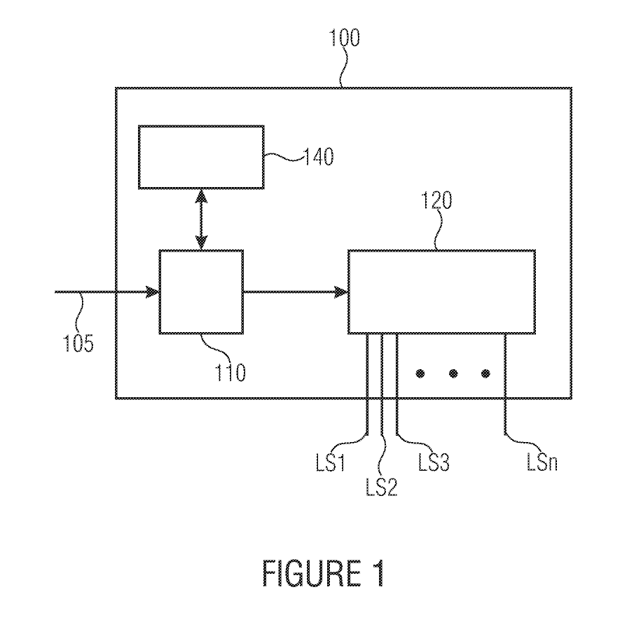

FIG. 1 shows a schematic illustration of a device for acoustic display 100 comprising an input 105, via which positional information of an object may be input into the device 100. The device 100 additionally comprises outputs for a plurality of loudspeaker signals LS (exemplarily for a first loudspeaker signal LS1, a second loudspeaker signal LS2, a third loudspeaker signal LS3, . . . , an nth loudspeaker signal LSn). The input for the positional information 105 is configured to signal objects including their positions to signal associating means 110. The signal associating means 110 is configured to associate an acoustic signal to the objects, the signal associating means 110 optionally accessing a signal database 140 to associate different signals—exemplarily using their danger potential—to different objects. The respective associated signals may exemplarily depend on whether the object is moving and, if so, at what speed, or whether it is stationary.

In addition, the device 100 comprises loudspeaker driving means 120 which receives the position of the object and the acoustic signal from the signal associating means 110 in order to establish one or several loudspeaker signals LS for a plurality of loudspeakers therefrom and output same via the outputs for the loudspeaker signals LS1, . . . , LSn. The loudspeaker driving means 120 is configured to establish the one or several loudspeaker signals LS based on the acoustic signal which has been associated to the object. Establishing is performed such that, when reproducing the one or several loudspeaker signals LS, the position of the object is displayed acoustically in the reproduction space. A listener (or user) will perceive the position (for example distance and direction) of the object as the position of a virtual sound source.

As has been mentioned, one embodiment relates to reproducing information of a radar establishing the positions of objects. In addition to or instead of the radar, information from other sources, like sonar, or other sensors may also be processed similarly. In this embodiment, which is exemplarily to be described in greater detail below, loudspeakers may exemplarily be arranged below windows (may be additionally also above the windows) on all the walls on the bridge of the ship. These loudspeakers may exemplarily all be equipped with their own amplifiers or A/D (analog-to-digital) transducers or converters and may additionally be driven individually. It is of particular advantage when the persons on the bridge can be surrounded by loudspeakers as completely as possible, wherein planar surrounding (circle) is useful or aimed at for civilian seafaring and even three-dimensional surrounding (hemisphere) for military applications. The surrounding here need not be complete and smaller gaps in the surrounding, which may, for example, be caused by doors, would also be possible.

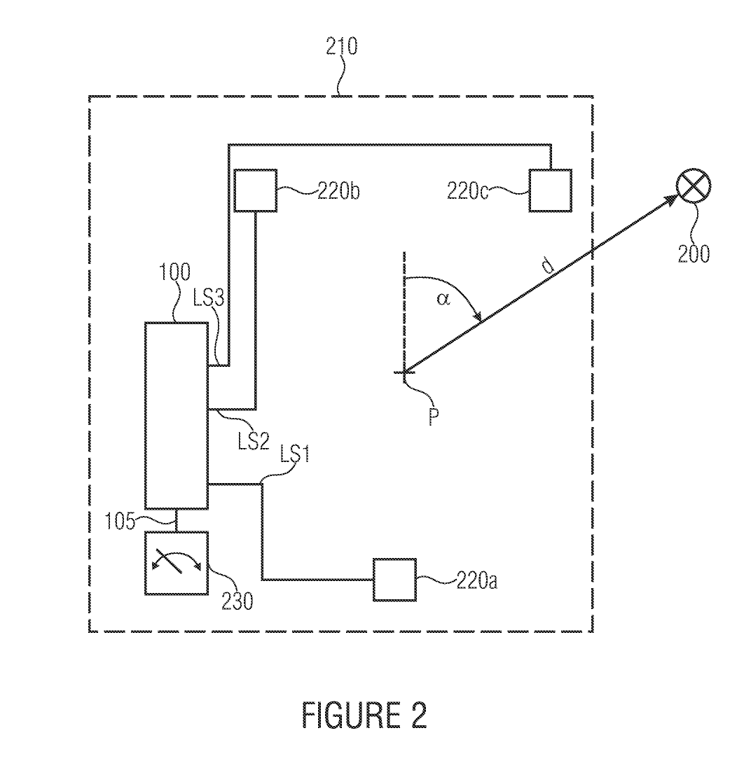

FIG. 2 shows a schematic illustration of a reproduction space 210 comprising three loudspeakers 220a, 22b and 220c and a radar 230. The radar 230 is connected to the input 105 and provides positional information on objects in the surroundings of the reproduction space 210. Exemplarily, the radar 230 is configured to pass on the position of the object 200 to the device 100 for acoustic display. The three loudspeakers 220a, 220b, 220c are additionally connected to the outputs for the loudspeaker signals LS of the device for acoustic display 100. Specifically, a first loudspeaker 220a is connected to the output for the first loudspeaker signal LS1, a second loudspeaker 220b to the output for the second loudspeaker signal LS2 and a third loudspeaker 220c to the output for the third loudspeaker signal LS3.

The device for acoustic display 100 evaluates the positional information of the object 200 it receives from the radar 230 to establish from this three loudspeaker signals LS1, LS2, LS3 for the first, second and third loudspeakers 220a, 220b, 220c. Establishing takes place in a manner such that the position of the object 200 is audible to the listener in the reproduction space 210 who is exemplarily located at a position P. At first, the device 100 establishes an acoustic signal for the object 200 in dependence on the position of the object 200. The position is determined by the distance d and the direction which may exemplarily be indicated using an angle α. Then, the device 100 calculates loudspeaker signals LS for the first to third loudspeakers 220a to 220c. This may exemplarily include scaling the signal level and delaying the signal so that the listener at the position P will perceive the object 200 according to his position. In the embodiment shown in FIG. 2, this may exemplarily take place such that the third loudspeaker 220c provides the strongest signal, whereas the first loudspeaker 220a only provides a low signal and the second loudspeaker 220b does not provide any signal.

The radar 230 shown in FIG. 2 may additionally be coupled to a sonar which exemplarily scans the underwater topography and signals shallows may be present, which may also be represented acoustically. For distinguishing purposes, different acoustic signals may be associated, as has been mentioned, to different objects (above water, below water or land-based objects).

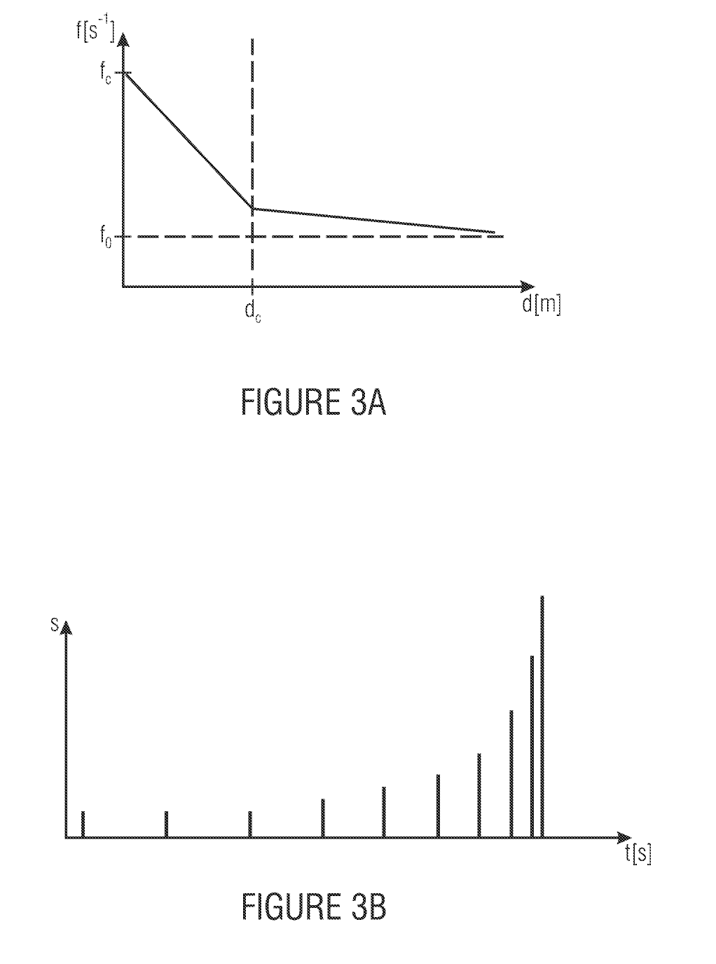

FIGS. 3a and 3b show potential variations of the acoustic signal in dependence on the distance of the object and the danger potential connected thereto.

FIG. 3a illustrates a dependence of a frequency f of the signal on the distance d of the object 200. As long as the object is at a sufficient distance, there is no or hardly any danger. When, however, the object comes too close and exemplarily goes below a critical distance dc, there is increased danger needing increased attention of the person navigating. This transition from a danger-free to a dangerous state may exemplarily be signaled in a changing acoustic signal. Exemplarily, when the distance is above the critical distance dc, the frequency f of the signal may be close to or only slightly above a fundamental frequency f0, the frequency range defined in this way being perceived by the person navigating as non-dangerous. When, however, the object decreases in distance such that it will be below the critical distance dc, the frequency f of the acoustic signal may suddenly increase strongly such that the person navigating is signaled the increasing danger.

The increase in frequency may optionally also increase monotonically with a decreasing distance of the object without there being an abrupt change at the critical distance such that a continually increasing danger potential becomes perceivable for the person navigating.

The acoustic signal or the frequency f of the acoustic signal may thus, on the one hand, include audio frequency or also clock frequency when, for example, the acoustic signal indicates a certain clock in a certain frequency (repetition rate of the clocks). With the clock signal, too, the clock frequency may increase with decreasing distance, so that an increasing danger potential will be perceivable acoustically for the person navigating.

FIG. 3b shows an embodiment in which the signal level S is represented as a function of time t. The distance between two neighboring clocks decreases with increasing time in this embodiment, so that the clock frequency increases so as to signal an approaching object. At the same time, the decreasing clock interval may be combined with the signal pulses becoming louder and/or the frequencies of the signal pulses changing. Changing the signal may exemplarily comprise shifting the center frequency towards higher frequencies so that the increasing danger potential also becomes perceivable in the frequency level or audio frequency of the signal pulses. As is shown in FIG. 3b, the amplitude or loudness of the signal may at the same time also increase with an increasing danger potential.

Generally, it is of advantage for the acoustic signals to be hardly perceivable in a danger-free state so that the person navigating is not disturbed by the acoustic signals.

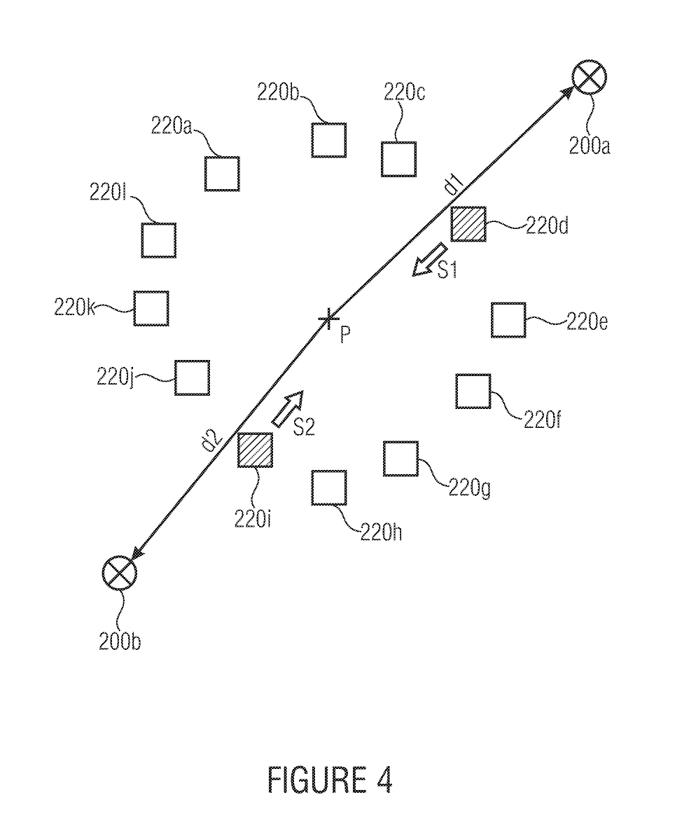

FIG. 4 shows an embodiment in which a plurality of loudspeakers 220 comprise a first loudspeaker 220a, . . . , a fourth loudspeaker 220d, . . . , a ninth loudspeaker 220i, . . . , a twelfth loudspeaker 2201. The loudspeakers 220 are arranged around the position P of a listener such that the position of an object 200 or the direction of the object 200 becomes perceivable by only one loudspeaker being active. In this embodiment, the position of the active loudspeaker at the same time corresponds to the direction of the object 200. This is of particular advantage when the position P is fixed to be in the reproduction space 210.

Exemplarily, as is shown in FIG. 4, two objects, a first object 200a at a distance d1 and a second object 200b at a distance d2 from the hearing point P, can be perceived by the fourth loudspeaker 220d generating a first sound signal S1 and the ninth loudspeaker 220i generating a second sound signal S2. The listener at the position P will then perceive the first object 200a and the second object in correspondence with their positions. The loudspeaker which has the smallest distance to the connecting line between the respective object and the position P may exemplarily be chosen as the active loudspeaker. With the first object 200a, this would be the fourth loudspeaker 220d and, with the second object 200b, the ninth loudspeaker 220i. All the other loudspeakers are further away from the respective connecting lines (measured as the perpendicular distance) and may exemplarily not be active in this embodiment (not generating sound signals).

Alternatively, it is also possible for the respective neighboring loudspeakers between which the connection line between the first object 200a and the position P is passing to be active. Additionally, further neighboring loudspeakers may also be active. This means that, exemplarily, in further embodiments not only the fourth loudspeaker 220d is active, but at the same time also the third loudspeaker 220c and/or the second loudspeaker 220b and/or the fifth loudspeaker 220e can be active. When, however, several loudspeakers are active at the same time so as to represent the position of one of the objects 200, the amplitude/phase is to be chosen such that the object 200 at its respective position will be acoustically perceivable for a listener at the position P. Acoustic perceptibility here means that the object 200 is perceived as a virtual sound source, wherein the distance may, apart from the loudness, also be signaled by a different clock frequency or audio frequency (as has exemplarily been illustrated in FIGS. 3a, b).

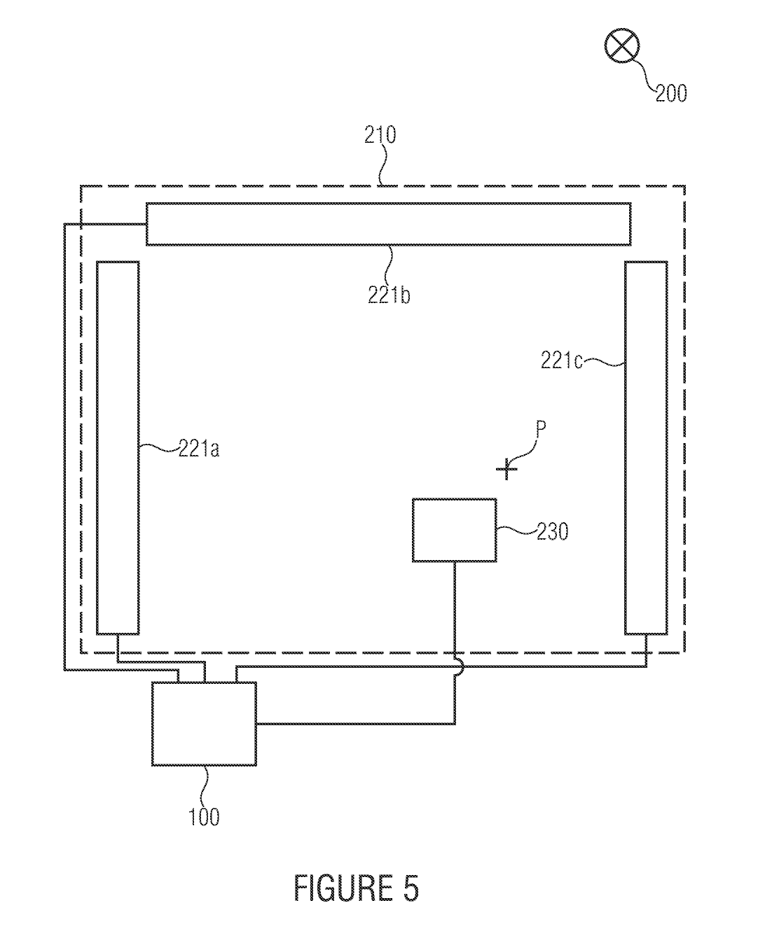

FIG. 5 shows an embodiment in which the loudspeakers are arranged in a wave field synthesis system such that the device for acoustic display 100 drives the first loudspeaker array 221a, a second loudspeaker array 221b and a third loudspeaker array 221c. Each of the three loudspeaker arrays 221a, 221b, 221c exemplarily comprises a plurality of loudspeakers which are exemplarily at a predetermined spatial distance to one another, and the device 100 is configured such that every loudspeaker in a respective array may be driven individually such that the three arrays which may exemplarily be arranged at the side walls of the reproduction space 210 synthesize a wave field which would generate an object 200 as a virtual sound source in the reproduction space 210. The device 100 in turn may be coupled to a radar or a sonar 230 which transmits the position of the respective objects to the device 100. The object itself need not be a sound source, but rather a sound signal is associated specifically to the object. In this respect, the acoustic display in accordance with embodiments differs from conventional audio reproduction systems.

The setup of a WFS system is generally very complex and is based on wave field synthesis. Wave field synthesis is an audio reproduction method, developed by the Technical University of Delft, for the spatial reproduction of complex audio scenes. In contrast to most existing methods for audio reproduction, spatially correct reproduction is not limited to a small region, but extends over an extended reproduction region. WFS is based on a well-founded mathematical-physical basis, namely the Huygens principle and the Kirchhoff-Helmholtz integral.

Typically, a WFS reproduction system includes a large number of loudspeakers (so-called secondary sources). The loudspeaker signals are formed from delayed and scaled input signals. Since typically many audio objects (primary sources) are used in a WFS scene, a very large number of such operations is needed for generating the loudspeaker signals. This causes the high computing power needed for wave field synthesis.

Apart from the advantages mentioned above, WFS also offers a way of mapping moving sources realistically. This feature is made use of in many WFS systems and is, for example, of great importance for being employed in cinemas, virtual-reality applications or live performances.

However, reproducing moving sources causes a number of characteristic errors which do not occur in the case of static sources. Signal processing of a WFS reproduction system has a significant influence on the quality of reproduction.

One primary goal is developing signal processing algorithms for reproducing moving sources by means of WFS. Thus, the real-time capability of the algorithm is an important prerequisite. The most important criterion for evaluating the algorithms is the audio quality as actually perceived.

As has been mentioned, WFS is a method for audio reproduction which is very complicated with regard to processing resources. This is, above all, caused by the great number of loudspeakers in a WFS setup and the, often, great number of virtual sources used in WFS scenes. For this reason, efficiency of the algorithms to be developed is of utmost importance.

Wave field synthesis systems are, compared to conventional multi-loudspeaker systems, of advantage in that they allow exact positioning and in that exact positioning may also be determined at various positions within the reproduction space 210.

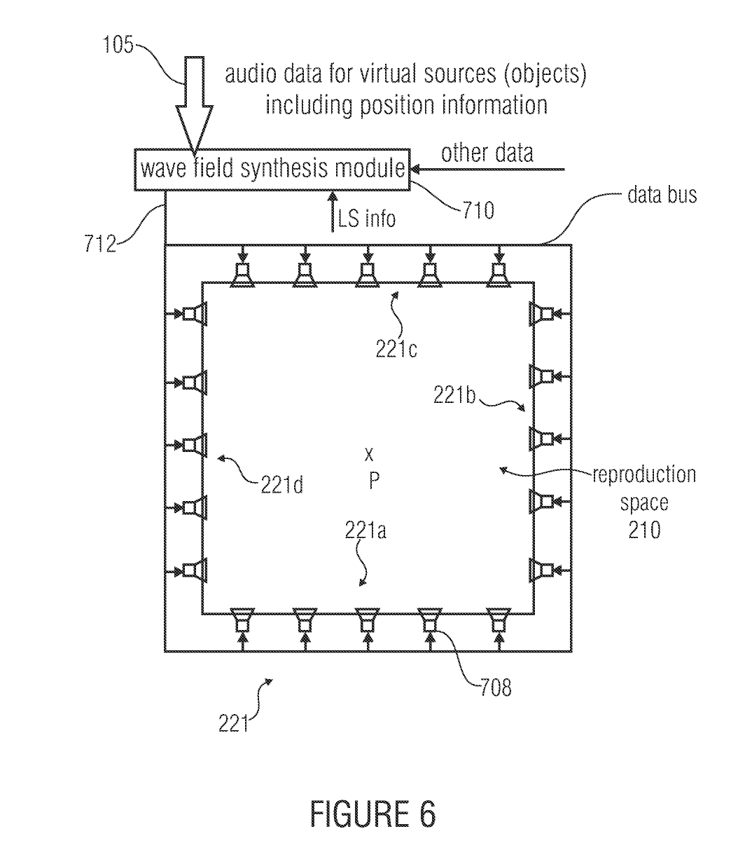

FIG. 6 shows a basic setup of a wave field synthesis system and exhibits a loudspeaker array 221 which is placed relative to a reproduction space 210. In particular, the loudspeaker array shown in FIG. 6, which is a 360° array, includes four array sides 221a, 221b, 221c and 221d. When, for example, the reproduction space 210 is a bridge on a ship, it is assumed, with regard to conventions regarding front/back or right/left, that the pre-alignment of the ship is on the same side of the reproduction space 210 on which the sub-array 221c is arranged, too. In this case, the user, who is here positioned at the so-called optimum point P in the reproduction space 210, would exemplarily be looking to the front. The sub-array 221a would then be behind the user, whereas the sub-array 221d would to the left of the viewer and the sub-array 221d would be to the right of the user.

Every loudspeaker array 221 includes a number of various individual loudspeakers 708 which are each driven by their own loudspeaker signals LS which are provided by a wave field synthesis module 710 via a data bus 712 which is only shown schematically in FIG. 6. The wave field synthesis module 710 is configured to calculate, using the information on, for example, type and position of the loudspeakers 708 relative to the reproduction space 210, i.e. loudspeaker information (LS info) and, maybe, using other data, loudspeaker signals LS for the individual loudspeakers 708 which are each derived from the audio data for virtual sources (=objects) to which further positional information is associated, in accordance with known wave field synthesis algorithms. The positional information are exemplarily established by a sensor for determining the position of objects (e.g. the radar) and provided to the wave field synthesis module via the input 105. The wave field synthesis module may still receive other inputs, such as, for example, comprise information on the spatial acoustics of the reproduction space 210, etc.

In embodiments making use of WFS of even TAP for driving the loudspeakers, the signal associating means 110 is configured to associate acoustic signal to several objects 200 and the loudspeaker driving means 120 is configured to generate component signals for each of the several objects 200 and to combine the component signals to form loudspeaker signals LS so that the several objects 100 are perceived acoustically at different positions. The different objects here may, as has been described before, appear to the listener to be or be perceived as virtual sources (sound sources).

Embodiments may exemplarily be supplemented or modified as follows. In further embodiments, boundary conditions in the ships may also be taken into consideration. The boundary conditions exemplarily include requirements to the frequency of reporting, possible positions of the loudspeakers, the sound pressure level needed, characterization of interfering sound (such as, for example, from the engine) and a specification of the drive signals for the acoustic display.

Using a database, optimum reporting signals may then be generated taking typical spatial sounds on ships into consideration.

In embodiments, acoustic driving includes technologies, such as, for example, binaural encoding or wave field synthesis described above. Thus, the different technologies are employed using test setups in ships (or one-to-one models of the bridge and/or the operation center). Psychoacoustic experiments may exemplarily provide corresponding information.

Embodiments use reporting signals which are locatable the best way possible in the ship's environment, but at the same time are to be of the most pleasant sound. Test setups in the laboratory or one-to-one models of the bridge and/or the operation center or in vehicles and psychoacoustic experiments are useful here.

Further embodiments additionally provide connecting sensors and information which are exemplarily obtained from radar, sonar and nautical charts to the acoustic display. A significant part of connecting is choosing the relevant objects which are exemplarily to be represented by means of acoustic displays.

In summary, embodiments exemplarily include the following aspects:
(a) using acoustic displays in ships;
(b) connecting radar, sonar and nautical charts to acoustic displays;
(c) connecting weather charts to acoustic displays;
(d) connecting radio buoys to acoustic displays for ships;
(e) selecting objects in dependence on the importance, in particular relative to the location and the relative or absolute speed of the ship and the objects (ships, underwater obstacles, etc.); and
(f) selecting reporting signals which sound pleasant.

Finally, the systems described may also be applied in automobiles, i.e. further embodiments also include corresponding systems of driving assistance in a car. Exemplarily, vehicles approaching laterally (e.g. when changing lanes) may be signaled acoustically.

It is particularly pointed out that, depending on the circumstances, the inventive scheme may also be implemented in software. The implementation may be on a digital storage medium, in particular on a disc or a CD having control signals which may be read out electronically which are able to cooperate with a programmable computer system such that the corresponding method will be executed. Generally, the invention thus also exists in a computer program product comprising program code stored on a machine-readable carrier for performing the inventive method when the computer program product runs on a computer. In other words, the invention may also be realized as a computer program having program code for performing the method when the computer program runs on a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1-21. (canceled)

22. A device for acoustic display of a position of an object in a reproduction space, at least three loudspeakers being arranged in the reproduction space at spatially different positions so that different spatial positions may be represented acoustically by differently driving the loudspeakers, comprising:
a signal associater configured to associate an acoustic signal to the object in dependence on the distance of the object and the danger potential connected thereto; and
a loudspeaker driver configured to establish one or several loudspeaker signals for the at least three loudspeakers,
wherein the one or several loudspeaker signals by which the position of the object is displayed are based on the acoustic signals associated to the object by the signal associater, and wherein the one or several loudspeaker signals may be established such that, when reproducing the one or several loudspeaker signals, the position of the object in the reproduction space is displayed acoustically.

23. The device in accordance with claim 22, wherein the signal associater is configured to associate an acoustic signal to the object even when the object itself is not a sound source.

24. The device in accordance with claim 22, further comprising a signal database connected to the signal associater, wherein the signal database is configured to provide various acoustic signals for various objects.

25. The device in accordance with claim 24, wherein the associated acoustic signal depends on whether the object is movable or static.

26. The device in accordance with claim 24, wherein acoustic signals in the signal database are classified in correspondence with a danger potential, and the signal associater is configured to associate acoustic signals from different classes to various objects in correspondence with their potential danger.

27. The device in accordance with claim 26, wherein acoustic signals of a higher danger potential comprise a higher audio frequency or a higher clock frequency.

28. The device in accordance with claim 26, wherein an acoustic signal of a high danger potential is associated to an object at a smaller distance and an acoustic signal of a smaller danger potential is associated to an object at a greater distance.

29. The device in accordance with claim 22, wherein the object comprises a relative speed to the reproduction space, and wherein the associated acoustic signal is dependent on the relative speed.

30. The device in accordance with claim 22, wherein the loudspeaker driver is configured to establish several loudspeaker signals for the at least three loudspeakers, wherein the at least three loudspeakers at least partly surround a position in the reproduction space in one plane.

31. The device in accordance with claim 22, wherein the signal associater additionally comprises an input which may be coupled to a sensor for determining the position of the object, and the sensor is configured to transmit the position of the object to the signal associater.

32. The device in accordance with claim 31, wherein the sensor comprises a radar or sonar.

33. The device in accordance with claim 31, wherein the object identifies itself by a textual notification, and the sensor is configured to pass on the textual notification to the input, and the device additionally comprises a text-to-speech module configured to convert the textual notification to an audio signal and pass same on to the loudspeaker driver.

34. The device in accordance with claim 22, wherein the loudspeaker driver is configured to establish exactly one loudspeaker signal for exactly one loudspeaker, wherein the loudspeaker may be placed in the reproduction space in the direction of the object.

35. The device in accordance with claim 34, wherein the exactly one loudspeaker signal drives exactly one other loudspeaker when the object changes its position.

36. The device in accordance with claim 22, wherein the signal associater is configured to associate acoustic signals to several objects, and wherein the loudspeaker driver is configured to generate component signals for each of the several objects and combine the component signals to form loudspeaker signals so that the several objects are perceivable acoustically at different positions.

37. The device in accordance with claim 22, wherein the loudspeaker driver is configured to encode the distance of the object by an audio frequency or clock frequency such that the distance of the object is perceivable at a predetermined scale.

38. The device in accordance with claim 22, wherein the signal associater is configured to associate an acoustic signal in a predetermined minimum bandwidth to the object such that the acoustic signal is clearly perceivable acoustically.

39. The device in accordance with claim 22, wherein the loudspeaker driver comprises a wave field synthesis system, the wave field synthesis system being configured to reproduce the acoustic signal associated to the object as a virtual source.

40. A device for scanning an environment, comprising:
a sensor for determining a position of an object in the environment; and
a device for acoustic display of a position of an object in a reproduction space, at least three loudspeakers being arranged in the reproduction space at spatially different positions so that different spatial positions may be represented acoustically by differently driving the loudspeakers, comprising: a signal associater configured to associate an acoustic signal to the object in dependence on the distance of the object and the danger potential connected thereto; and
a loudspeaker driver configured to establish one or several loudspeaker signals for the at least three loudspeakers, wherein the one or several loudspeaker signals by which the position of the object is displayed are based on the acoustic signals associated to the object by the signal associater, and wherein the one or several loudspeaker signals may be established such that, when reproducing the one or several loudspeaker signals, the position of the object in the reproduction space is displayed acoustically, coupled to the sensor and receiving the position of the object from the sensor.

41. The device in accordance with claim 40, wherein the sensor comprises a radar or sonar.

42. A method for acoustic display of a position of an object in a reproduction space, at least three loudspeakers being arranged in the reproduction space at spatially different positions such that different positions may be represented acoustically by differently driving the loudspeakers, comprising:
associating an acoustic signal to an object in dependence on the distance of the object and the danger potential connected thereto; and
establishing one or several loudspeaker signals for the at least three loudspeakers,
wherein the one or several loudspeaker signals by which the position of the object is displayed are established based on the acoustic signal associated to the object by the signal associater, and wherein the one or several loudspeaker signals are established such that, when reproducing the one or several loudspeaker signals, the position of the object in the reproduction space is displayed acoustically.

43. A tangible computer readable medium including a computer program comprising program code for performing, when the computer program runs on a computer, a method for acoustic display of a position of an object in a reproduction space, at least three loudspeakers being arranged in the reproduction space at spatially different positions such that different positions may be represented acoustically by differently driving the loudspeakers, comprising: associating an acoustic signal to an object in dependence on the distance of the object and the danger potential connected thereto; and establishing one or several loudspeaker signals for the at least three loudspeakers, wherein the one or several loudspeaker signals by which the position of the object is displayed are established based on the acoustic signal associated to the object by the signal associater, and wherein the one or several loudspeaker signals are established such that, when reproducing the one or several loudspeaker signals, the position of the object in the reproduction space is displayed acoustically.
